(19) United States
(12) Patent Application Publication
(10) Pub. No.: US 2024/0193839 A1
(43) Pub. Date: Jun. 13, 2024

(54) AUTOMATICALLY GENERATING A CUSTOM ARTIFICIALLY INTELLIGENT (AI) CHARACTER BASED ON A USER-PROVIDED DESCRIPTION OF THE AI CHARACTER

(71) Applicants: Arif Ali Khan, Oakland, CA (US); Ahmad Bukhsh Matyana, Glen Elly, IL (US)

(72) Inventors: Arif Ali Khan, Oakland, CA (US); Ahmad Bukhsh Matyana, Glen Elly, IL (US)

(21) Appl. No.: 18/535,380

(22) Filed: Dec. 11, 2023

Related U.S. Application Data
(60) Provisional application No. 63/387,071, filed on Dec. 12, 2022.

(51) Int. Cl. G06T 13/40; G06T 13/80; G10L 13/033; G10L 13/047; G10L 15/18

(52) U.S. Cl. CPC G06T 13/40; G06T 13/80; G10L 13/033; G10L 13/047; G10L 15/1822; G06N 3/006; G06T 2200/24

(57) ABSTRACT

Some examples of the present disclosure related to converting a text description input by a user into an artificially intelligent character. In one example, a system can receive a user input that includes a description of a custom artificially intelligent (AI) character. The system can then automatically generate the custom AI character based on the description. For example, the system can generate a personality dataset based on the description, a voice dataset based on the description, and/or an appearance dataset based on the description. The system can then provide the custom AI character using the personality dataset, the voice dataset, and/or the appearance dataset.

### CROSS-REFERENCE TO RELATED APPLICATION

This application claims priority to U.S. Provisional Application No. 63/387,071, titled “AUTOMATICALLY GENERATING A CUSTOM ARTIFICIALLY INTELLIGENT (AI) CHARACTER BASED ON A USER-PROVIDED DESCRIPTION OF THE AI CHARACTER” and filed on Dec. 12, 2022, the entirety of which is hereby incorporated by reference herein.

### TECHNICAL FIELD

This application relates generally to artificially intelligent (AI) characters. More specifically, but not by way of limitation, this disclosure relates to automatically generating an AI character based on a user-provided description of the AI character.

### BACKGROUND

Artificially intelligent characters can be animated characters with lifelike qualities that are capable of learning and interacting. Artificially intelligent characters may have lifelike features, such as a face with hair, eyes, ears, cheeks, and a mouth that may be capable of movement to produce facial expressions. Artificially intelligent characters may also include other body parts, such as legs, arms, feet, etc.

### SUMMARY

One example of the present disclosure includes a computer-implemented method. The method can involve receiving a user input that includes a description of a custom artificially intelligent (AI) character. The method can also involve, in response to receiving the user input, automatically constructing the custom AI character. The custom AI character can be automatically constructed by: generating a personality dataset based on the description, the personality dataset describing personality characteristics of the custom AI character; generating a voice dataset based on the description, the voice dataset describing voice characteristics of the custom AI character; and/or generating an appearance dataset based on the description, the appearance dataset describing a visual appearance of the custom AI character. The method can also involve providing the custom AI character based on the personality dataset, the voice dataset, and the appearance dataset.

Another example of the present disclosure can include a non-transitory computer-readable medium comprising program code that is executable by one or more processors for causing the one or more processors to perform operations. The operations can involve receiving a user input that includes a description of a custom artificially intelligent (AI) character. The operations can also involve, in response to receiving the user input, automatically constructing the custom AI character. The custom AI character can be automatically constructed by: generating a personality dataset based on the description, the personality dataset describing personality characteristics of the custom AI character; generating a voice dataset based on the description, the voice dataset describing voice characteristics of the custom AI character; and/or generating an appearance dataset based on the description, the appearance dataset describing a visual appearance of the custom AI character. The operations can also involve providing the custom AI character based on the personality dataset, the voice dataset, and the appearance dataset.

Yet another example of the present disclosure can include a system comprising one or more processors and one or more memories. The one or more memories can include instructions that are executable by the one or more processors for causing the one or more processors to perform operations. The operations can involve receiving a user input that includes a description of a custom artificially intelligent (AI) character. The operations can also involve, in response to receiving the user input, automatically constructing the custom AI character. The custom AI character can be automatically constructed by: generating a personality dataset based on the description, the personality dataset describing personality characteristics of the custom AI character; generating a voice dataset based on the description, the voice dataset describing voice characteristics of the custom AI character; and/or generating an appearance dataset based on the description, the appearance dataset describing a visual appearance of the custom AI character. The operations can also involve providing the custom AI character based on the personality dataset, the voice dataset, and the appearance dataset.

These illustrative examples are mentioned not to limit or define the scope of this disclosure, but rather to provide examples to aid understanding thereof. It will be appreciated that examples described above may be combined with other examples described above or elsewhere herein to yield further examples. Illustrative examples are also discussed in the Detailed Description, which provides further description. Advantages offered by various examples may be further understood by examining this specification.

### BRIEF DESCRIPTION OF THE DRAWINGS

Illustrative embodiments are described with reference to the following figures.

FIG. 1 shows a block diagram of an example of a system for automatically generating an AI character based on a user-provided description of the AI character according to some aspects of the present disclosure.

FIG. 2 shows an example of a graphical user interface for receiving a text description of an AI character according to some aspects of the present disclosure.

FIG. 3 shows an example of a graphical user interface for presenting an AI character according to some aspects of the present disclosure.

FIG. 4 shows an example of a graphical user interface for interacting with an AI character according to some aspects of the present disclosure.

FIG. 5 shows a block diagram of an example of a system for generating an interaction response associated with the AI character according to some aspects of the present disclosure.

FIG. 6 shows an example of a process for generating an AI character according to some aspects of the present disclosure.

FIG. 7 shows an example of a process for interacting with an AI character according to some aspects of the present disclosure.

FIG. 8 shows a block diagram of an example of a computing device usable to implement some aspects of the present disclosure.

### DETAILED DESCRIPTION

Certain aspects and features of the present disclosure related to automatically generating a custom artificially intelligence (AI) character based on natural language input from a user. The natural language input can describe features of the AI character, such as its personality, voice, and appearance. The natural language input can be provided in any suitable human language, such as English. The system can process the natural language input to understand the features of the AI character. The system can then automatically construct an AI character with those features. Because the natural language input uses normal words and phrases, the system does not require the user to have any programming skill or advanced knowledge to create a custom AI character. This can greatly simplify the process of generating custom AI characters so that it is more accessible to the average user.

To generate the AI character based on a natural language input, the system can begin by processing the natural language input to generate a personality dataset, a voice dataset, and an appearance dataset. The personality dataset can describe the personality characteristics of the AI character. Examples of the personality characteristics can include intelligence attributes, psyche attributes, identity attributes, skill attributes, etc. The voice dataset can describe the voice characteristics of the AI character. Examples of the voice characteristics can include pitch, cadence, language, etc. The appearance dataset can describe the visual appearance characteristics of the AI character. Examples of the visual appearance can include the gender, facial features, hair features, clothing, etc. The system can use the voice dataset to generate a voice model for the AI character. The system can also use the appearance dataset to generate an image for the AI character. The personality dataset, voice model, and image can then be collectively stored as a package for the AI character. The package can define the AI character. The package may be shareable among users to share the AI character.

To interact with the AI character, the user may be able to provide a user input to the system, such as a chat message in a natural language format. The system can detect the user input, generate a textual response based on the personality dataset and the user input, and generate a spoken (e.g., synthetic speech) response to the user input based on the textual response. To generate the spoken response, the system can use the voice model associated with the AI character. The system can also generate a visual response based on the image and the user input. The system can then provide the textual response, the spoken response, and/or the visual response to the user. This can simulate the AI character's response to the user interaction. The textual response, spoken response, and/or visual response may be output to the user concurrently to one another to more realistically simulate the AI character's response.

These illustrative examples are provided to introduce the reader to the general subject matter discussed here and are not intended to limit the scope of the disclosed concepts. The following sections describe various additional features and examples with reference to the drawings in which similar numerals indicate similar elements but, like the illustrative examples, should not be used to limit the present disclosure.

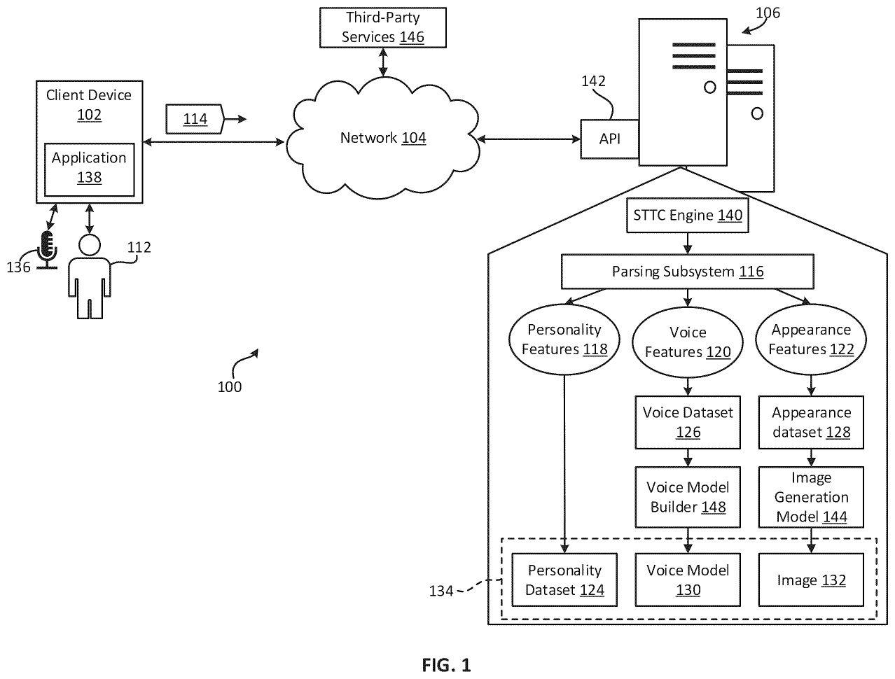

FIG. 1 shows a block diagram of an example of a system 100 for automatically generating an AI character (e.g., a custom AI character) based on a user-provided description of the AI character according to some aspects of the present disclosure. The system 100 includes a client device 102 in communication with a computer system 106 via a network 104, such as the Internet or a local area network. Examples of the client device 102 can include a laptop computer, desktop computer, mobile phone, tablet, e-reader, or wearable device such as a smart watch.

A user 112 can operate the client device 102 to provide user input 114 to the client device 102. The user input 114 can describe an AI character to be generated by the computer system 106. The description can be in a natural-language format and may contain unstructured text written in a human language, such as English, French, or Spanish.

In some examples, the user input 114 can be provided as a textual input (e.g., a natural-language text input) describing the AI character. The user 112 can operate a keyboard or a touchscreen of the client device 102 to provide the textual input. The textual input may contain one or more lines of text and any number of words. For instance, the textual input may consist of a single line of text with fewer than 50 words. In other examples, the user input 114 can be a speech input (e.g., a natural-language speech input) describing the AI character. The user 112 can operate a microphone 136 of the client device 102 to provide the speech input. Regardless of the type of the user input 114, the user input 114 can include a description of the features of the AI character. For example, the user input 114 can describe personality features, voice features, and/or visual features of the AI character.

After receiving the user input 114, the client device 102 can transmit the user input 114 to the computer system 106 via the network 104. For example, the computer system 106 can provide a website or another user interface through which the user 112 can input the description of the AI character to the computer system 106. In some such examples, the user 112 can navigate a website browser of the client device 102 to the website. Once at the website, the user 112 can provide the user input 114 to the computer system 106 via the website. As another example, the client device 102 can provide the user input 114 to the computer system 106 via an application programming interface (API) 142 of the computer system 106. For instance, the client device 102 can execute an application 138 that is configured to transmit the user input 114 to the computer system 106 via the API 142. The application 138 may be any suitable type of application, such as a mobile application downloaded from an application (“app”) store. The application 138 may be created by a third party, where the third party is different from the user 112 and an entity operating the computer system 106. Alternatively, the application 138 may be created by the entity operating the computer system 106.

The computer system 106 can receive the user input 114 and responsively initiate a process to automatically construct the AI character. If the user input 114 is a speech input, the process may begin with the computer system 106 converting the speech input into a corresponding text input using a speech-to-text conversion (STTC) engine 140. The speech-to-text conversion engine 140 may include one or more models, such as deep neural networks, decision trees, classifiers, and other machine-learning models. One example of such a model can include a natural-language model. The speech-to-text conversion engine 140 may be able to process natural-language speech and convert it into corresponding text for use in subsequent operations by the computer system 106. Alternatively, if the user input 114 is already a textual input, these speech-to-text conversion steps can be skipped.

The process may next involve the computer system 106 providing the user input 114 in textual form to a parsing subsystem 116. The parsing subsystem 116 can be configured to parse the user input 114 into one or more sets of features, such as personality features 118, voice features 120, and appearance features 122. The personality features 118 can include keywords and other information that is extracted from the user input 114 and related to the personality of the AI character. The voice features 120 can include keywords and other information that is extracted from the user input 114 and related to the voice of the AI character. The appearance features 122 can include keywords and other information that is extracted from the user input 114 and related to the visual appearance of the AI character.

To perform the abovementioned parsing, the parsing subsystem 116 may include models, rule sets, algorithms, or any combination of these. Examples of such models may include deep neural networks, decision trees, classifiers, or other machine-learning models. In some examples, the parsing subsystem 116 can include one or more natural-language processing models configured to understand and process natural-language inputs, such as the user input 114. The natural-language processing models may analyze the syntax, grammar, and parts of speech associated with the user input 114. These models can be trained using any suitable approach. For example, the models may be trained based on a set of training data that maps certain words and phrases to different corresponding categories (e.g., personality, voice, and appearance). Once trained, the model may then be able to analyze a user input 114 and classify portions thereof into the different categories.

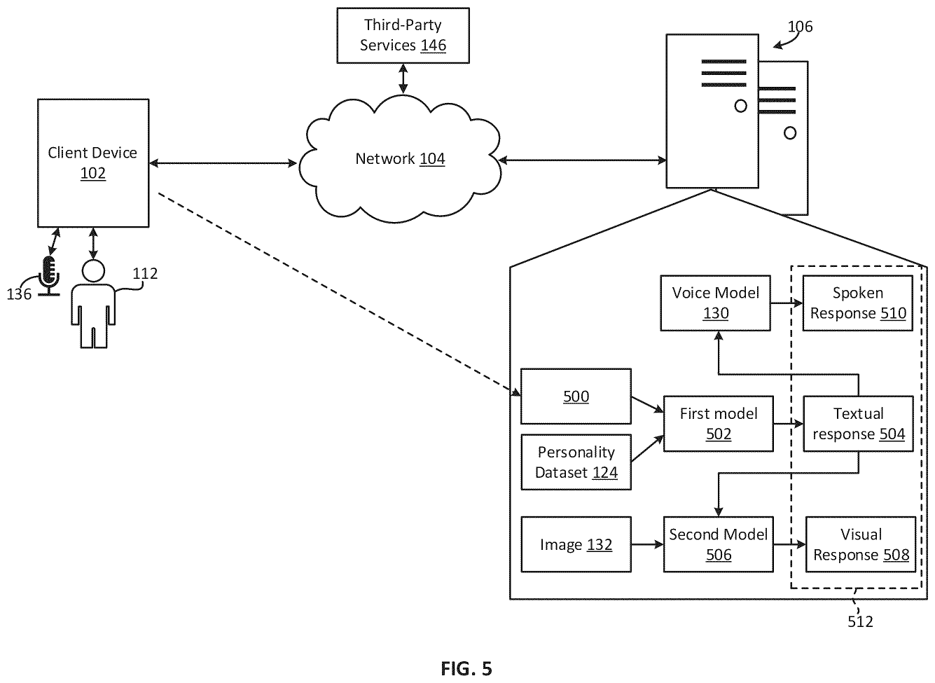

After parsing the user input 114 into one or more sets of features, the computer system 106 can generate one or more corresponding datasets, such as a personality dataset 124, a voice dataset 126, and an appearance dataset 128. For example, the computer system 106 can generate the personality dataset 124 based on the personality features 118 extracted from the user input 114. The personality dataset 124 can describe the personality characteristics of the AI character. Examples of the personality characteristics can include intelligence attributes (e.g., intelligence level, knowledge, and learning capabilities), psyche attributes (e.g., empathy, self-interest, and behavioral traits), identity attributes (e.g., name, age, family, and backstory), and skill attributes (e.g., active or latent capabilities). As one specific example, the personality dataset 124 can include a personality profile that defines the AI character's likes, dislikes, skills, backstory, relationships, family tree, psychology, and/or behavioral patterns. The personality dataset 124 can have any suitable format. For instance, the personality dataset 124 may be formatted as a prompt that is configured to be provided as input to a trained model, as described in greater detail later on with respect to FIG. 5. The prompt may be generated by filling in fields of a predefined template.

In some examples, the user input 114 may not specify personality features or may specify an insufficient amount of personality features to generate a useful personality dataset 124. In some such examples, the system 100 may prompt (e.g., ask) the user 112 to provide additional input that includes the personality features. Additionally or alternatively, the system 100 may supplement the user input 114 with a default personality dataset to generate the personality dataset 124. For instance, if the user input 114 includes the name of a celebrity but does not expressly specify any personality features, the computer system 106 generate the personality dataset 124 based at least in part on a default personality dataset corresponding to that celebrity. Different default personality datasets may be created for different entities (e.g., celebrities, companies, cartoon characters, etc.) based on videos, recordings, photos, and other information about the entities and used to supplement the user input 114. The appropriate default personality dataset may be selected, from among multiple available default datasets, based on the content of the user input 114.

As noted above, the computer system 106 can also generate a voice dataset 126 based on the voice features 120 extracted from the user input 114. The voice dataset 126 can describe the voice characteristics of the AI character. Examples of the voice characteristics can include pitch, cadence, tone, magnitude, language, and speech pattern. As one specific example, the voice dataset 126 can include a voice profile that defines the tone, cadence, and/or language for the voice of the AI character. In some examples, the computer system 106 can also generate the voice dataset 126 based on the personality features 118, since the AI character's personality may influence its voice.

In some examples, the user input 114 may not specify voice features or may specify an insufficient amount of voice features to generate a useful voice dataset 126. In some such examples, the system 100 may prompt (e.g., ask) the user 112 to provide additional input that includes the voice features. Additionally or alternatively, the system 100 may supplement the user input 114 with a default voice dataset to generate the voice dataset 126. For instance, if the user input 114 includes the name of a celebrity but does not expressly specify any voice features, the computer system 106 generate the voice dataset 126 based at least in part on a default voice dataset corresponding to that celebrity. Different default voice datasets may be created for different entities based on videos, recordings, and other information about the entities and used to supplement the user input 114. The appropriate default voice dataset may be selected, from among multiple available default datasets, based on the content of the user input 114.

After generating the voice dataset 126, in some examples the computer system 106 can generate a voice model 130 based on the voice dataset 126. For example, the computer system 106 can execute a voice model builder 148 to construct the voice model 130 based on the voice dataset 126. In some examples, the voice model 130 may be a trained machine-learning model, such as a neural network. The voice model 130 can be configured to generate synthetic speech outputs based on textual inputs, where the synthetic speech outputs are consistent with the voice dataset 126. For example, the voice model 130 can perform text-to-speech conversion to convert a textual input into a synthetic speech output. Because the voice model 130 is generated based on the voice dataset 126, the voice model 130 can produce synthetic speech having the characteristics defined in the voice dataset 126.

In some examples, the computer system 106 can additionally or alternatively generate an appearance dataset 128 based on the appearance features 122 extracted from the user input 114. The appearance dataset 128 can describe the visual appearance characteristics of the AI character. Examples of the visual appearance can include the gender, age, height, facial features, hair features, clothing, accessories, race, and ethnicity of the AI character. As one specific example, the appearance dataset 128 can include a visual profile that defines the clothing, facial features, and/or hair color of the AI character. In some examples, the computer system 106 can also generate the appearance dataset 128 based on the personality features 118, since the AI character's personality may influence its visual appearance.

In some examples, the user input 114 may not specify appearance features or may specify an insufficient amount of appearance features to generate a useful appearance dataset 128. In some such examples, the system 100 may prompt the user 112 to provide additional input that includes the appearance features. Additionally or alternatively, the system 100 may supplement the user input 114 with a default appearance dataset to generate the appearance dataset 128. For instance, if the user input 114 includes the name of a celebrity but does not expressly specify any appearance features, the computer system 106 generate the appearance dataset 128 based at least in part on a default appearance dataset corresponding to that celebrity. Different default appearance datasets may be created for different entities based on videos, photos, and other information about the entities and used to supplement the user input 114. The appropriate default appearance dataset may be selected, from among multiple available default datasets, based on the content of the user input 114.

After generating the appearance dataset 128, in some examples the computer system 106 can generate an image 132 of the AI character based on the appearance dataset 128. For example, the computer system 106 can provide the appearance dataset 128 as input to one or more image generation models 144, which can be configured to generate an image 132 of an AI character that is consistent with the appearance dataset 128. In some examples, the image generation model 144 can be a trained neural network, such as a generative neural network. One specific example of the image generation model 144 can be Stable Diffusion model, which is a latent diffusion model. Another example of the image generation model 144 can be DALL-E-2 by Open AI. The image generation model 144 can be trained using any suitable approach. For example, the image generation model 144 may be trained based on a set of training data that maps certain words and phrases to different image features. One example of the training data can be LAION-5B, which is a publicly available dataset derived from Common Crawl data scraped from the web. Once trained, the image generation model 144 may be able to construct an image that includes the image features specified in the appearance dataset 128.

The AI character can be defined by the image 132, the voice model 130, and/or the personality dataset 124, some or all of which may be stored as a definition package 134 for the AI character. Each AI character may have its own definition package 134, which can represent that AI character. The definition package 134 for an AI character may be shareable with other users or transferrable to other users, so as to share or transfer the AI character. For example, some or all of the definition package 134 can be saved as a non-fungible token (NFT) on a blockchain. The NFT can represent the AI character on the blockchain and can be transferred between entities, for example by transferring the NFT between their digital wallets. In effect, this may transfer the AI character or ownership rights in the AI character. In some examples, the AI character can be sold, licensed, or traded on secondary markets such as OpenSea®. This may be achieved by transferring the corresponding definition package 134 between entities via the secondary markets. As will be described in greater detail later on, the definition package 134 can be ingested by the computer system 106 to “bring the AI character to life,” for example to allow for user interactions with the AI character.

In some examples, the computer system 106 can include editorial controls (e.g., filters) to prevent the user 112 from creating objectionable content, such as an unauthorized celebrity character, pornography, or a vulgar character. For instance, the computer system 106 can analyze the user input 114 for certain terms and phrases that are suggestive of certain celebrities. If the computer system 106 detects such terms and phrases in the user input 114, the computer system 106 can notify the user 112 and block the creation of the corresponding AI character.

In some examples, the user 112 may be able to incorporate third-party services 146 into the generation of the AI character. To do so, the user 112 can include a link to an endpoint for a third-party service 146 in the user input 114. A third-party service 146 can be a service that is hosted by a third party. A third party can be a party other than the user 112 and the computer system 106. The user 112 may also include one or more authentication credentials (e.g., an API key, a username, and a password) for accessing the third-party service 146 in the user input 114. The user 112 may further include one or more commands to be used with the third-party service 146 in the user input 114. After receiving the user input 114, the computer system 106 can extract the link, the authentication credentials, and the commands for the third-party service 146 from the user input 114. The computer system 106 can perform this extraction using the parsing subsystem 116. The computer system 106 can then access the link/endpoint using the authentication credentials to generate, for example, at least some of the personality dataset 124, the voice model 130, the image 132, or other relevant information for the AI character. In some examples, the computer system 106 may store the link, the authentication credentials, and the commands for subsequent use. For instance, such information may be used again later on when generating the AI character's “responses” to subsequent user inputs.

The third-party services 146 can include any suitable types of computing services that can provide data to the computer system 106. For instance, the third-party services 146 may include machine-learning models, such as deep neural networks, large language models, etc. In some examples, the third-party services 146 may include image generation models, voice model builders, etc. As one particular example, to generate the image 132 for the AI character, the user 112 may wish to override the default image generation model 144 with another image generation model of a third-party service 146. To that end, the user 112 can incorporate an API link for the other image generation model, along with a corresponding API command and API key, into the user input 114. The computer system 106 can detect this information in the user input 114, extract it from the user input 114, and use it to obtain the image 132 from the third-party service 146. For instance, the computer system 106 can access the link using the authentication credentials and submit the API command to the API of the third-party service 146. The third-party service 146 can respond to the API command by generating and providing the image 132 to the computer system 106. A similar technique may be used to obtain the voice model 130, or other information related to the AI character, from a third-party service 146.

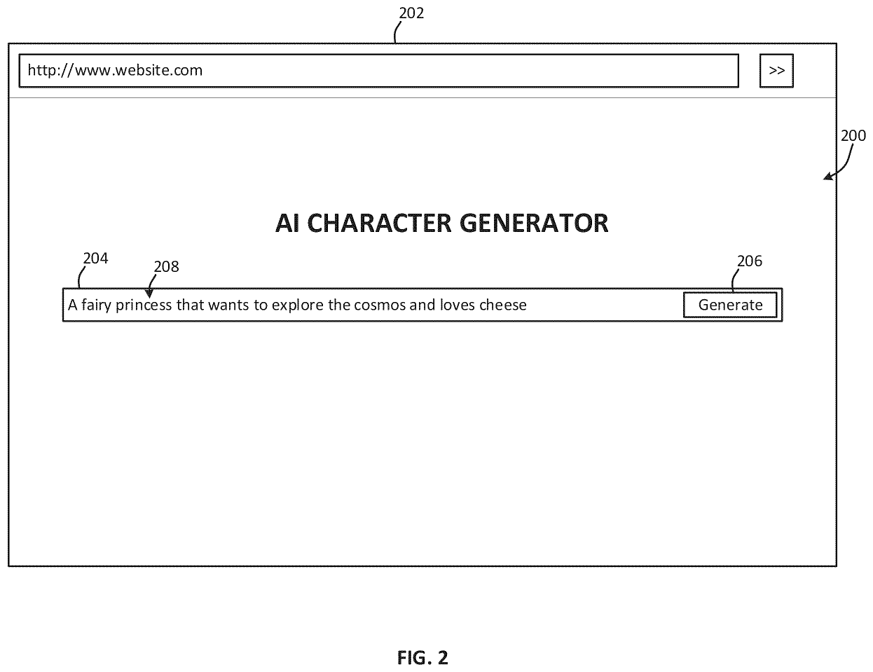

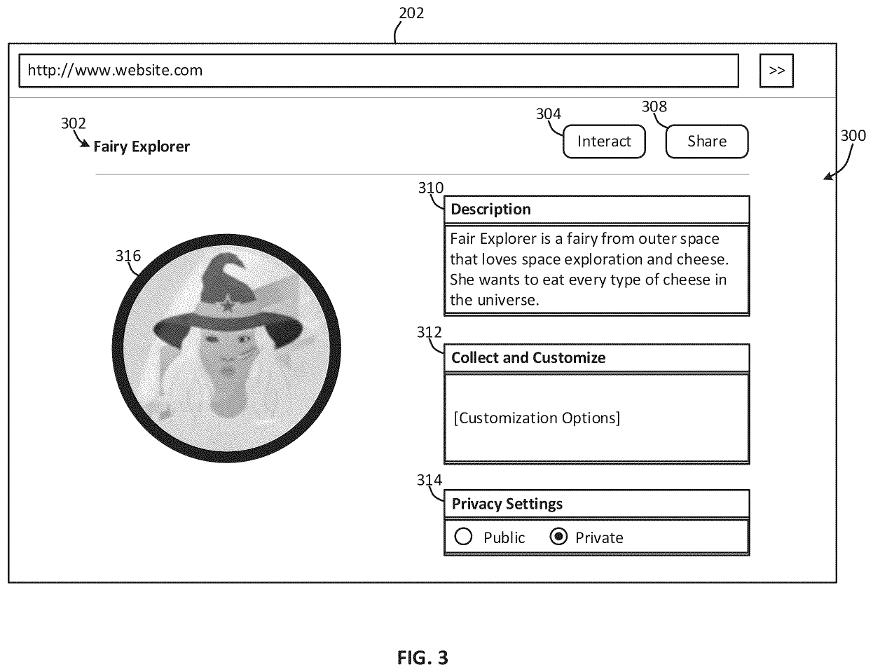

Referring now to FIG. 2, shown is an example of a graphical user interface (GUI) 200 for receiving a description 208 of an AI character according to some aspects of the present disclosure. In this example, the GUI 200 is part of a webpage visited by a user using a website browser 202. The GUI 200 includes a text box 204 into which a user can input a description 208 of the custom AI character. This can serve as the user input 114 described above. The description 208 can be a natural-language sentence that describes various features of the custom AI character, such as its type, desires, and preferences. The description 208 can be a single sentence that uses normal words and phrases, and therefore does not require the user to have any programming skill or advanced knowledge. This can greatly simplify the process of generating a custom AI character so that it is more accessible to the average user. After inputting the description 208 into the text box 204, the user can select a button 206 to initiate the process for automatically creating the custom AI character, at which point the graphical user interface may transition to the GUI page 300 shown in FIG. 3.

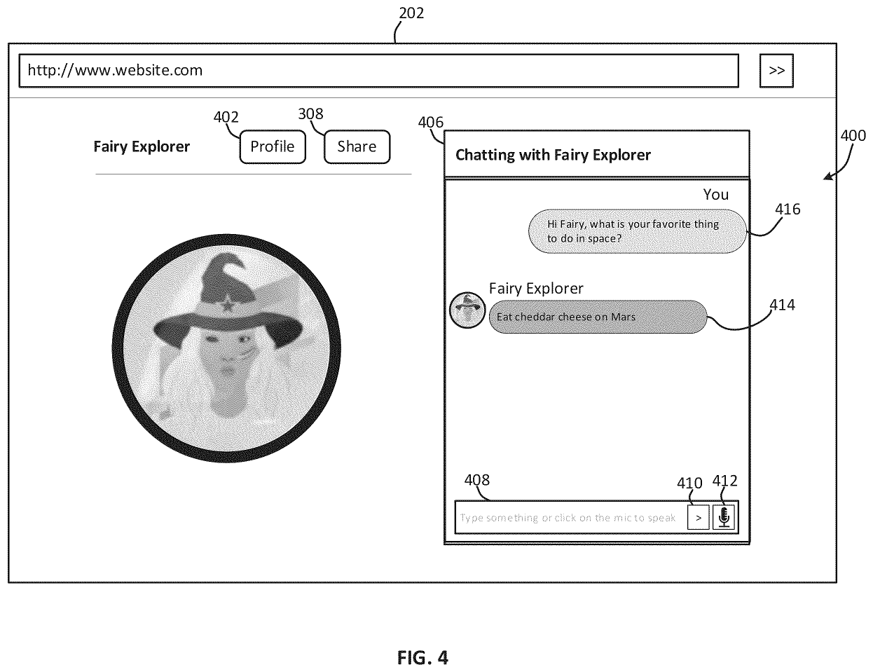

As shown in FIG. 3, the GUI page 300 can include a name 302 and a visual depiction 316 of the AI character. The visual depiction 316 may be, for example, the image 132 generated by the computer system 106. The computer system 106 can also generate a description 310 (e.g., a narrative) of the custom AI character and include it in the GUI page 300. The description 310 can be a natural-language description generated (e.g., using one or more trained models) based on the description 208 input by the user. The GUI page 300 may also include other options, such as privacy settings 314 for making the custom AI character publicly accessible or private to the creator, customization settings 312 for further modifying (e.g., customizing) the characteristics of the custom AI character, a sharing option 308 for sharing the custom AI character with someone else (e.g., a friend or acquaintance), and an interaction option 304 for engaging an interactions with the custom AI character. If the user selects the interaction option 304, the graphical user interface may transition to the GUI page 400 shown in FIG. 4.

As shown in FIG. 4, the GUI page 400 can include the sharing option 308 for sharing the AI character with someone else. The GUI page 400 can also include a profile option 402, which when selected can transition the graphical user interface back to the GUI page 300 so that the user may view the profile of the custom AI character. In some examples, the GUI page 300 can further include an interaction component 406 through which the user can interact with the custom AI character. In this example, the interaction component 406 is a chat interface through which the user can engage in a chat session with the custom AI character. But in other examples, the interaction component 406 may provide other ways for interacting with the custom AI character.

To chat with the AI character, the user can input a chat message into a chat box 408. For example, the user can type the chat message into the chat box 408. Alternatively, the user can select a speech-to-text option 412, which can convert the user's speech into a chat message in the chat box 408. After inputting the chat message into the chat box 408, the user can select a submit button 410 to send the chat message 416. Of course, since the AI character is not a real entity, the concept of “chatting with the AI character” really involves the user interacting with the computer system 106 and the computer system 106 providing corresponding responses.

In some examples, the computer system 106 can receive the chat message 416 and generate a response attributable to the AI character. The response may include a visual, auditory, and/or textual components. For example, the computer system 106 can generate a response message 414, which can be a textual chat message that is output in the chat interface. The computer system 106 can customize the response message 414 based on the personality dataset 124, so that the response message 414 is consistent with the personality characteristics of the AI character. The computer system 106 can also output a spoken version of the response message 414, which can simulate the AI character speaking the text of the response message 414. The computer system 106 can further animate the AI character, for example so that it has facial expressions and body movements that correspond to the rest of the response. This combination of the textual, spoken, and/or visual responses can make the AI character seem more lifelike to the user.

One example of a system for generating such an interaction response associated with an AI character is shown in FIG. 5. In this example, the user 112 can initiate an interaction with the AI character, for example by providing a textual input 500 such as a chat message or by providing another kind of user input. The user 112 may provide the user input to the client device 102, which in turn may transmit the user input to the computer system 106 for processing.

The computer system 106 can detect the user interaction and automatically generate a corresponding response 512. For example, the computer system 106 can detect the user interaction and initiate a process for generating a response 512 attributable to the AI character. The process can involve accessing the definition package (e.g., definition package 134) for the AI character to obtain the personality dataset 124, image 132, and/or voice model 130. The computer system 106 can then provide the personality dataset 124, and optionally data associated with the user interaction such as the content of the textual input 500, as input to a first model 502. The first model 502 may include a deep neural network, such as a generative model. One example of such a generative model can include the generative pre-trained transformer 3 (GPT-3) model. The first model 502 can output a textual response 504 based on the input. The textual response 504 is a response in a textual format. The textual response 504 can be generated by the first model 502 in accordance with the personality dataset 124, so that the textual response 504 is consistent with the personality of the AI character.

The first model 502 can be trained using any suitable approach. For example, the first model 502 may be trained based on a set of training data that maps certain personality characteristics, and words and phrases, to different responses. Once trained, the first model 502 may then be able to analyze the textual input 500, identify key words and phrases therein, and construct a response that is consistent with the personality dataset 124.

In some examples, the computer system 106 can provide the textual response 504 as input to the voice model 130. The voice model 130 can generate a spoken response 510 based on the textual response 504. For example, the spoken response 510 may be synthetic speech corresponding to the textual response 504. In particular, the spoken response 510 can be a spoken version of the textual response 504. Thus, the voice model 130 can convert the textual response 504 into an auditory spoken response 510.

Additionally or alternatively, the computer system 106 can provide the textual response 504 and the image 132 as input to a second model 506. The second model 506 may include a deep neural network, such as a generative model like a generative adversarial network (GANs). Based on the inputs, the second model 506 can output a visual response 508, such as a static image or animation, corresponding to the textual response 504. For example, the second model 506 can be an animation model configured to generate a visual response 508 that includes an animation. The animation may be a facial expression or other movement associated with the textual response 504. For example, the animation can include lip movements configured to simulate the AI character speaking some or all of the content of the textual response 504. The animation may additionally or alternatively include body movements, such as body movements configured to simulate the AI character acting out some or all of the content of the textual response 504. The visual response 508 may be stored as a *.gif file, a video file, or another type of file.

The second model 506 can be trained using any suitable approach. For example, the second model 506 may be trained based on a set of training data that maps certain key words and phrases to different visual responses. Once trained, the second model 506 may then be able to analyze the textual input 500, identify key words and phrases therein, and construct a relevant visual response 508.

After generating the textual response 504, the spoken response 510, and/or the visual response 508, some or all of these may be provided back to the user 112 as the response 512 to the interaction. For example, the computer system 106 can concurrently (e.g., simultaneously) output the visual response 508, the textual response 504 and/or the spoken response 510, so that the user 112 perceives these modalities concurrently. This may enhance the realism of the AI character for the user 112.

In some examples, the computer system 106 can use API information for a third-party service 146 to generate the response 512 to the user interaction. For example, the original user input 114 used to create the AI character, or a subsequent user input to the AI character, may have included links and authentication credentials for one or more third-party services 146. In some such examples, the computer system 106 can generate the response 512 by acquiring information from the third-party services 146 using the links and authentication credentials. For instance, the computer system 106 can interact with an API of a third-party service 146 to request the textual response 504, the spoken response 510, the visual response 508, and/or other information. Based on the request, the third-party service 146 can generate and provide at least part of the textual response 504, the spoken response 510, the visual response 508, and/or the other information. The computer system 106 can then incorporate any of the above into the overall response 512 to the user interaction. In this way, a user 112 may be able to override or supplement the default models 130, 502, 506 of the computer system 106 with third-party services 146, to facilitate generating the response 512.

It will be appreciated that although FIGS. 1-5 show examples in which the AI character is created and maintained by a computer system 106 (e.g., a cloud computing environment) based on requests from a remote client device 102, in other examples the functionality of the computer system 106 may be alternatively performed by the client device 102. For example, the client device 102 may download a standalone application configured to perform some or all of the functionality described herein with respect to the computer system 106. The client device 102 can then execute the application to, for example, generate the AI character and its responses to user interactions.

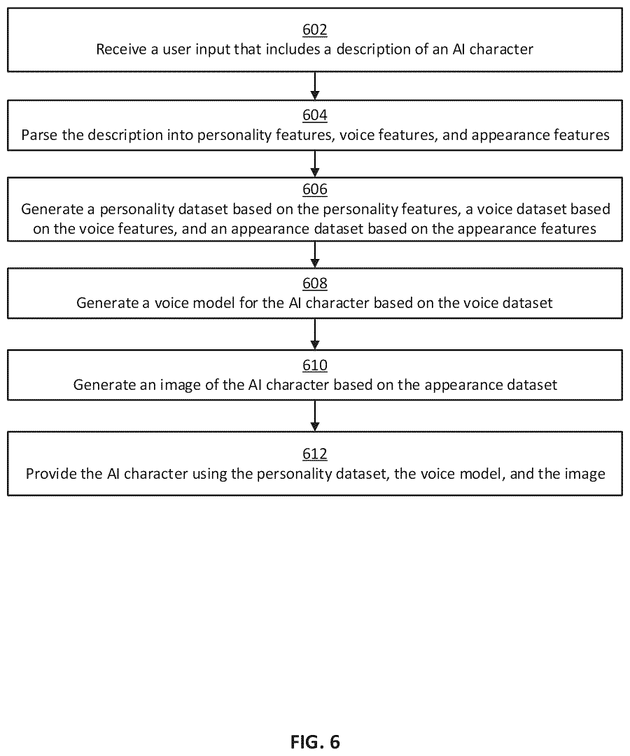

FIG. 6 shows an example of a process for generating an AI character (e.g., a custom AI character) according to some aspects of the present disclosure. Other examples may include more operations, fewer operations, different operations, or a different order of operations than is shown in FIG. 6. The operations of FIG. 6 are described below with reference to the components of FIGS. 1 and 5 described above.

In block 602, a computer system 106 receives user input 114 that includes a description (e.g., description 208 of FIG. 2) of a custom AI character. The computer system 106 can receive the user input 114 from a client device 102 via a network 104, such as a public or private network.

In block 604, the computer system 106 parses the description into personality features 118, voice features 120, and appearance features 122. In other examples, the computer system 106 may parse the description into more or fewer sets of features. For instance, if the description does not include any voice features, the computer system 106 may only parse the description into personality features 118 and appearance features 122. The computer system 106 may then use default voice features in place of the parsed voice features 120. As another example, if the description does not include any appearance features, the computer system 106 may only parse the description into personality features 118 and voice features 120. The computer system 106 may then use default appearance features in place of the parsed appearance features 122.

In block 606, the computer system 106 generates a personality dataset 124 based on the personality features 118, a voice dataset 126 based on the voice features 120, and an appearance dataset 128 based on the appearance features 122. Of course, in other examples, the computer system 106 may generate more or fewer datasets. For instance, if the description does not include any voice features, the computer system 106 may only generate the personality dataset 124 and the appearance dataset 128. The computer system 106 may then use a default voice dataset in place of the generated voice dataset 126. As another example, if the description does not include any appearance features, the computer system 106 may only generate the personality dataset 124 and the voice dataset 126. The computer system 106 may then use a default appearance dataset in place of the generated appearance dataset 128.

In block 608, the computer system 106 generates a voice model 130 for the AI character based on the voice dataset 126. The voice model 130 can be configured to generate synthetic speech with characteristics defined in the voice dataset 126. In some examples, the computer system 106 can execute a voice model builder 148 to create the voice model 130. The voice model builder 148 can be software configured to construct a voice model that is consistent with the input voice dataset 126.

In block 610, the computer system 106 generates an image 132 of the AI character based on the appearance dataset 128. The image 132 can visually depict at least some of the features described in the appearance dataset 128. In some examples, the computer system 106 can execute an image generation model 144 to create the image 132. The image generation model 144 can be software configured to generate an image 132 that is consistent with the input appearance dataset 128.

In block 612, the computer system 106 provides the AI character using the personality dataset 124, the image 132, and the voice model 130. Because the AI character is not a real entity, it will be appreciated that providing the AI character may involve the computer system 106 generating expressions, interactions, and responses, and performing various tasks, that it attributes to the AI character.

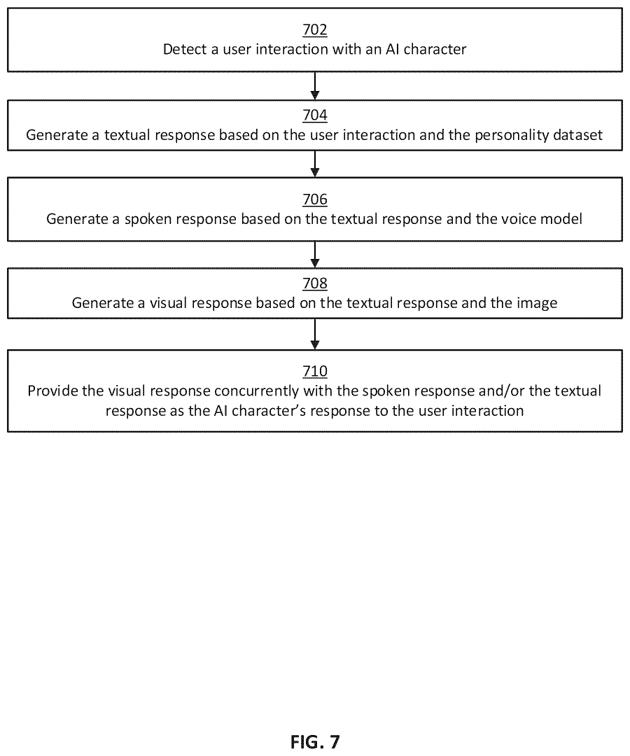

FIG. 7 shows an example of a process for interacting with a custom AI character according to some aspects of the present disclosure. Other examples may include more operations, fewer operations, different operations, or a different order of operations than is shown in FIG. 7. The operations of FIG. 7 are described below with reference to the components of FIGS. 1 and 5 described above.

In block 702, the computer system 106 detects a user interaction with an AI character (e.g., a custom AI character) by a user 112. For example, the computer system 106 can receive a user input for interacting with the AI character. The computer system 106 may receive the user input via a webpage, an API 142, or another interface. In some examples, the user input can be a textual input 500 such as a chat message.

In block 704, the computer system 106 generates a textual response 504 based on the user interaction and the personality dataset 124. For example, the computer system 106 can retrieve the personality dataset 124 associated with the AI character and provide it as input to a first model 502. The computer system 106 can also provide aspects of the user interaction (e.g., the text of the textual input 500) as input to the first model 502. Based on these inputs, the first model 502 can generate the textual response 504. The textual response 504 can be generated by the first model 502 in accordance with the personality dataset 124, so that the textual response 504 is consistent with the personality of the AI character.

In block 706, the computer system 106 generates a spoken response 510 based on the textual response 504 and the voice model 130. For example, the computer system 106 can provide the textual response 504 as input to the voice model 130, which can generate an audio file for playback that includes a synthetically spoken version of the textual response 504.

In block 708, the computer system 106 generates a visual response 508 based on the textual response 504 and the image 132. For example, the computer system 106 can provide the textual response 504 and the image 132 as input to a second model 506, which can be different from the first model 502. The second model 506 can generate a video file or a graphics interchange format (gif) file for playback that includes the visual response 508.

In block 710, the computer system 106 provides the visual response 508 concurrently with the spoken response 510 and/or the textual response 504. This can serve as the AI character's reply 512 to the user interaction. For example, the computer system 106 can output the visual response 508 substantially simultaneously with the spoken response 510 and the textual response 504 to the user 112. In some examples, these responses may be output substantially simultaneously in a webpage or an application 138 for viewing by the user 112. The computer system 106 can attribute these responses to the AI character, so that it seems from the user's perspective like the AI character has provided the response 512.

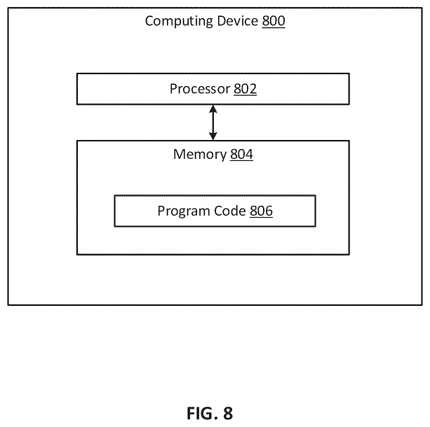

FIG. 8 shows a block diagram of an example of a computing device 800 usable to implement some aspects of the present disclosure. The computing device 800 may correspond to the client device 102 or the computer system 106 described above. For example, the computing device 800 may be part of the computer system 106 and capable of performing any of the functionality described above with reference to the computer system 106.

The computing device 800 can include a processor 802 communicatively coupled to a memory 804. The processor 802 can include one processing device or multiple processing devices. Examples of the processor 802 include a Field-Programmable Gate Array (FPGA), an application-specific integrated circuit (ASIC), or a microprocessor. The processor 802 can execute program code 806 stored in the memory 804 to perform operations. In some examples, the program code 806 can include processor-specific instructions generated by a compiler or an interpreter from code written in any suitable computer-programming language, such as C, C++, C#, etc.

The memory 804 can include one memory device or multiple memory devices. The memory 804 can be volatile or non-volatile (it can retain stored information when powered off). Examples of the memory 804 include electrically erasable and programmable read-only memory (EEPROM) and flash memory. At least some of the memory 804 includes a non-transitory computer-readable medium from which the processor 802 can read program code 806. A computer-readable medium can include electronic, optical, magnetic, or other storage devices capable of providing the processor 802 with computer-readable instructions or other program code. Examples of a computer-readable medium include magnetic disks, memory chips, ROM, random-access memory (RAM), an ASIC, a configured processor, optical storage, or any other medium from which a computer processor can read the program code 806.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A computer-implemented method comprising:
receiving a user input that includes a description of a custom artificially intelligent (AI) character;
in response to receiving the user input, automatically constructing the custom AI character by:
generating a personality dataset based on the description, the personality dataset describing personality characteristics of the custom AI character;
generating a voice dataset based on the description, the voice dataset describing voice characteristics of the custom AI character; and
generating an appearance dataset based on the description, the appearance dataset describing a visual appearance of the custom AI character; and
providing the custom AI character based on the personality dataset, the voice dataset, and the appearance dataset.

1. The method of claim 1, wherein the personality characteristics comprise intelligence attributes, psyche attributes, identity attributes, and skill attributes.

3. The method of claim 1, further comprising:
generating a voice model for the custom AI character based on the voice dataset; and
generating an image of the custom AI character based on the appearance dataset.

4. The method of claim 3, further comprising:
generating an auditory expression associated with the custom AI character by using the voice model; and
generating a visual movement associated with the custom AI character by providing the image as input to a generative adversarial network (GAN).

5. The method of claim 3, further comprising, subsequent to automatically generating the custom AI character:
detecting a user interaction with the custom AI character by a user;
in response to detecting the user interaction:
generating a textual response by providing the personality dataset and data associated with the user interaction as input to a first deep learning model, the first deep learning model being configured to generate the textual response to be consistent with the personality characteristics of the custom AI character based on the personality dataset;
generating a spoken response by providing the textual response as input to the voice model, the spoken response including a synthetic speech version of the textual response; and
generating a visual response by providing the image and the textual response as input to a second deep learning model, the visual response including an animated facial expression associated with the spoken response; and
providing the visual response concurrently with the spoken response and the textual response to the user as the custom AI character's response to the user interaction.

6. The method of claim 1, further comprising:
parsing, using a parsing subsystem, the description of the custom AI character into (i) personality features associated with the personality characteristics of the custom AI character, (ii) voice features associated with the voice characteristics of the custom AI character, and (iii) appearance features associated with the visual appearance of the custom AI character; and
generating the personality dataset based on the personality features, the voice dataset based on the voice features, and the appearance dataset based on the appearance features.

7. The method of claim 6, wherein the parsing subsystem includes one or more trained models.

8. The method of claim 1, further comprising:
receiving the user input through a graphical user interface of a webpage; and
presenting the custom AI character in the webpage.

9. The method of claim 1, further comprising receiving the user input from a third party via an application programming interface (API).

10. The method of claim 1, wherein the user input is received as textual input from a user.

11. The method of claim 1, wherein the user input is received as speech input from a user, and further comprising:
converting the speech input into a textual input using one or more natural-language models; and
generating the personality dataset, the voice dataset, and the appearance dataset based on the textual input.

12. A non-transitory computer-readable medium comprising program code that is executable by one or more processors for causing the one or more processors to perform operations including:
receiving a user input that includes a description of a custom artificially intelligent (AI) character;
in response to receiving the user input, automatically constructing the custom AI character by:
generating a personality dataset based on the description, the personality dataset describing personality characteristics of the custom AI character;
generating a voice dataset based on the description, the voice dataset describing voice characteristics of the custom AI character; and
generating an appearance dataset based on the description, the appearance dataset describing a visual appearance of the custom AI character; and
providing the custom AI character based on the personality dataset, the voice dataset, and the appearance dataset.

13. The non-transitory computer-readable medium of claim 12, wherein the personality characteristics comprise intelligence attributes and psyche attributes.

14. The non-transitory computer-readable medium of claim 12, wherein the operations further comprise:
generating an image of the custom AI character based on the appearance dataset.

15. The non-transitory computer-readable medium of claim 14, wherein the operations further comprise:
generating a visual movement associated with the custom AI character by providing the image as input to a generative adversarial network (GAN).

16. The non-transitory computer-readable medium of claim 14, wherein the operations further comprise, subsequent to automatically generating the custom AI character:
detecting a user interaction with the custom AI character by a user;
in response to detecting the user interaction:
generating a textual response by providing the personality dataset as input to a first deep learning model, the first deep learning model being configured to generate the textual response to be consistent with the personality characteristics of the custom AI character based on the personality dataset; and
generating a visual response by providing the image and the textual response as input to a second deep learning model, the visual response including an animated movement associated with the textual response; and
providing the visual response to the user as the custom AI character's response to the user interaction.

17. The non-transitory computer-readable medium of claim 12, wherein the operations further comprise:
parsing the description of the custom AI character into (i) personality features associated with the personality characteristics of the custom AI character, (ii) voice features associated with the voice characteristics of the custom AI character, and (iii) appearance features associated with the visual appearance of the custom AI character; and
generating the personality dataset based on the personality features, the voice dataset based on the voice features, and the appearance dataset based on the appearance features.

18. The non-transitory computer-readable medium of claim 12, wherein the operations further comprise:
receiving the user input through a graphical user interface of a webpage; and
presenting the custom AI character in the webpage.

19. The non-transitory computer-readable medium of claim 12, wherein the description is provided as natural-language textual input from a user.

20. The non-transitory computer-readable medium of claim 12, wherein the user input is received as natural-language speech input from a user, and wherein the operations further comprise:
converting the natural-language speech input into a textual input using one or more natural-language models; and
generating the personality dataset, the voice dataset, and the appearance dataset by analyzing the textual input.

21. A system comprising:
one or more processors; and
one or more memories including instructions that are executable by the one or more processors for causing the one or more processors to perform operations including:
receiving a user input that includes a description of an artificially intelligent (AI) character;
in response to receiving the user input, automatically constructing the AI character by:
generating a personality dataset based on the description, the personality dataset describing personality characteristics of the AI character; and
generating an appearance dataset based on the description, the appearance dataset describing a visual appearance of the AI character; and
providing the AI character based on the personality dataset and the appearance dataset.
